(19) United States
(12) Patent Application Publication
(10) Pub. No.: US 2010/0098385 A1
(43) Pub. Date: Apr. 22, 2010

(54) Optical module locking mechanism and method of locking and releasing a locking state of an optical module

(75) Inventor: Yuuji Minota, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 12/588,390

(22) Filed: Oct. 14, 2009

(30) Foreign Application Priority Data
Oct. 21, 2008 (JP) 2008-270761

(51) Int. Cl. G02B 6/36

(52) U.S. Cl. 385/92; 385/88

(57) ABSTRACT

An optical module locking mechanism for engaging and locking together a case, that makes up an optical module and that incorporates elements for performing optical communication, and a cage that accommodates the case includes: a locking member provided in a manner that allows pivoting in the case and that includes a detaining projection that can engage with and be detained by a detaining hole formed in the cage; a lever provided in the case in a manner that allows sliding parallel to the direction of extraction of the case from the cage; and an biasing member provided in the case for biasing the lever toward a prescribed position. The optical module locking mechanism is configured such that: in a state in which the case is accommodated in the cage and in which the lever is in a prescribed position, the detaining projection of the locking member is detained in the detaining hole; and the lever, in the course of sliding from the prescribed position along the direction of extraction of the case against the biasing force of the biasing member comes into contact with the locking member and thus causes the locking member to pivot inside the case, whereby the detention of the detaining projection in the detaining hole is released.

This application is based upon and claims the benefit of priority from Japanese patent application No. 2008-270761, filed on Oct. 21, 2008, the disclosure of which is incorporated herein in its entirety by reference.

### BACKGROUND OF THE INVENTION

1. Field of the Invention

The present invention relates to a locking mechanism of an optical module and to a method of locking and releasing a locking state of an optical module. In particular, the present invention relates to a locking mechanism for securing a case of an optical module, which incorporates elements for optical communication for realizing any of transmitting, receiving, and transceiving of optical signals, to a cage that accommodates the case, and relates to a method of locking and unlocking the optical module.

2. Description of the Related Art

Optical transceivers are known as optical modules for performing optical communication, these optical transceivers being equipped with light-emitting elements or light-receiving elements for effecting photoelectric conversion to carry out communication by means of optical fiber.

Such optical transceivers include a type that is configured such that an optical unit that includes light-emitting elements or light-receiving elements is incorporated in a case, and such that this case is detachably accommodated in a cage that is installed on a substrate. Electrical connectors that are connected to the substrate are provided in the cage. When the optical transceiver is accommodated in the cage, connection terminals of a connector unit of the optical transceiver connect to the electrical connectors in the cage. An optical transceiver that is configured in this way enables optical communication by the mutual conversion of optical signals that are transmitted and received between the optical transceiver and optical fibers and electrical signals that are transmitted and received between the optical transceiver and substrate.

In the above-described configuration, the optical transceiver is secured to the cage by the connection of its connector unit to the electrical connectors in the cage. However, the securing strength is not great, and as a result, the optical transceiver is detached from the cage upon application of only slight tensile force to the optical fiber that is connected to the optical transceiver. If the optical transceiver is pulled out from the cage during the operation of the optical transceiver, not only is communication cut off while in progress, but also the danger also arises of breakdown of the communication device that includes the optical transceiver. As a result, the optical transceiver must be firmly secured in the cage.

In order to firmly secure the optical transceiver in the cage, the provision of a locking mechanism is considered for maintaining the state in which the case of the optical transceiver is secured to the cage. Constructions employing a variety of methods have been proposed as such a locking mechanism.

For example, the locking mechanism of a connector that is disclosed in Japanese Patent Application Laid-open No. 119951/94 (H06-119951) is made up of male connector A made of synthetic resin, female connector B made of synthetic resin, and fit-driving lever C that is rotatably provided on female connector B, as shown in FIG. 1. When this locking mechanism is applied to an optical transceiver such as described hereinabove, it is a construction in which male connector A corresponds to the optical transceiver (the case), female connector B corresponds to the cage, and fit-driving lever C is provided on female connector B (cage).

Cam-grooves 202 are formed in fit-driving lever C of this locking mechanism. Lock engaging part 204 is provided on manipulation part 203 of fit-driving lever C. Locking projection 204c that includes tapered engagement guide surface 204a and engaging surface 204b is provided in lock engaging part 204.

Driven pins 205 are provided on two sidewalls of male connector A. Approximately L-shaped locking part 207 is provided in cavity 206 of the outer wall. Flexible locking plate 207a is installed upright in cavity 206 of locking part 207. Lock release manipulation part 207b is provided on the upper end of flexible locking plate 207a to extend toward the rear of male connector A. Lock detention hole 207c is formed in flexible locking plate 207a. Excessive-displacement-prevention stopper 207d is provided on the rear side of flexible locking plate 207a.

A hood for receiving male connectors A is provided in front of female connectors B. Pin guide grooves 208 for receiving driven pins 205 are formed on the inner surfaces of the two sides of this hood. These pin guide grooves 208 are linked to entrances 202a of cam grooves 202 that are formed in fit-driving lever C that is in the non-manipulated state (upright position).

In this locking mechanism, driven pins 205 of male connector A are caused to advance into cam grooves 202 from pin guide grooves 208. By using manipulation part 203 to rotate fit-driving lever C when in this state, male connectors A are pulled into the hood of female connector B by means of cam grooves 202 and driven pins 205, whereby male connectors A and female connectors B are interconnected. When fit-driving lever C is then completely rotated in this state, lock engaging part 204 and locking part 207 engage. More specifically, locking projection 204c of lock engaging part 204 comes into contact with flexible locking plate 207a of locking part 207 due to tapered engagement guide surface 204a. Locking projection 204c then enters lock detention hole 207c while displacing flexible locking plate 207a toward the rear. Engaging surface 204b then is detained in lock detention hole 207c of flexible locking plate 207a that has returned to its initial position, so that lock engaging part 204 and locking part 207 engage.

By adopting this type of locking mechanism, an optical transceiver can be firmly secured in the cage. However, when this locking mechanism is adopted, two operations must be carried out when attaching the optical transceiver to the cage, specifically, an operation for inserting the optical transceiver (male connectors A) into the cage (female connectors B), and an operation for turning down fit-driving lever C to cause lock engaging part 204 to engage with locking part 207. In addition, two operations must be carried out when detaching the optical transceiver from the cage, i.e., an operation of pressing lock release manipulation part 207b to displace flexible locking plate 207a toward the rear and thus release the engagement of lock detention hole 207a and locking projection 204c to release the locking state, and an operation of returning fit-driving lever C to its original position shown in FIG. 1.

The plurality of operations that is thus required for detaching the optical transceiver from the cage in the locking mechanism disclosed in Japanese Patent Application Laid-open No. 119951/94 (H06-119951) complicates the detachment of the optical transceiver, and the detachment is particularly inconvenient when a communication device includes a multiplicity of optical transceivers.

In recent years, moreover, various devices such as communication devices are becoming more compact and more densely arranged, and with this development, optical modules such as optical transceivers that are provided in communication devices are also becoming more compact and more densely arranged. Packaging a plurality of optical transceivers in a communication device with high density requires the vertical and horizontal alignment of a plurality of adjacent optical transceivers. However, if the optical transceivers are equipped with the locking mechanism of Japanese Patent Application Laid-open No. 119951/94 (H06-119951), space must be maintained to move manipulation part 203 of fit-driving lever C between the positions above and forward of the cage. As a result, a plurality of cages cannot be aligned vertically in close proximity, and consequently, a plurality of optical transceivers cannot be packaged at high density in a communication device.

In response, an optical module locking mechanism is proposed in Japanese Patent Application Laid-open No. 2004-170594 that both enables the detachment of the optical module from the cage by an easy operation and that enables packaging of a plurality of optical modules at high density in a communication device.

The optical module locking mechanism described in Japanese Patent Application Laid-open No. 2004-170594 includes locking member 211 that is pivotally attached in case 210 and lever 212 that can cause locking member 211 to pivot, as shown in FIG. 2. Detention projection (locking part) 211a of locking member 211 is able to engage with detention hole 213a formed in cage 213. In this locking mechanism, lever 212 is caused to rotate forward around rotation shaft 212a, when in a state in which case 210 is completely accommodated in cage 213 and detention projection 211a is engaged with detention hole 213a, whereupon lever 212 rides over lever stop 214. When lever 212 is further rotated, lever 212 contacts and presses down shoulder 211b of the forward part of locking member 211, whereupon locking member 211 pivots around support shaft 215 and its rear portion is raised. Detention projection 211a accordingly exits from detention hole 213a. When detention projection 211 a exits from detention hole 213a due to this rotation of lever 212 around rotation shaft 212a, the locking state in which case 210 is locked to cage 213 is released. As a result, case 210 can be extracted from cage 213. In addition, the range of movement of lever 212 is limited to within the region forward of the front-end surface of case 210.

Japanese Patent Application Laid-open No. 2004-309576 discloses a locking mechanism that is equipped with case (package main body) 221, leaf spring 223, and release member 224, as shown in FIG. 3. Case 221 is inserted into cage 220 in a manner that allows insertion and extraction. Leaf spring 223 includes locking part 222 provided on case 221 in a manner that allows protrusion from case 221 or receding into case 221 in a direction that intersects with the direction of insertion and extraction of case 221. Release member 224 is provided on case 221 in a manner that allows sliding in the direction of insertion and extraction of case 221. In this locking mechanism, locking part 222 engages with cage 220 such that the movement of case 221 in the direction of extraction of case 221 is constrained. The sliding of release member 224 in the direction of extraction of case 221 causes locking member 222 to enter entirely into case 221 and allows release of case 221 from cage 220.

The configurations of Japanese Patent Application Laid-open No. 2004-170594 and Japanese Patent Application Laid-open No. 2004-309576 are effective for achieving a high-density arrangement of a plurality of optical modules.

In the configuration disclosed in Japanese Patent Application Laid-open No. 2004-170594, as in the configuration disclosed in Japanese Patent Application Laid-open No. 119951/94 (H6-119951), an operation of at least two steps is required when detaching case 210 from cage 213, i.e., an operation for causing lever 212 to pivot and thus release the locking state, and an operation for causing lever 212 to slide parallel in order to extract case 210.

In the locking mechanism disclosed in Japanese Patent Application Laid-open No. 2004-170594, the operations of lever 212 (rotation, pulling out, pushing in) are carried out within the range of the thickness of cage 213 (equivalent to the thickness of the optical module). In other words, the range of rotation of lever 212 is constrained by the thickness of cage 213 (equivalent to the thickness of the optical module). If lever 212 is too long, the range of rotation within cage 213 becomes narrower (rotation angle becomes smaller) and sufficient rotation cannot be obtained. Thus, in order to guarantee sufficient rotation range of lever 212, lever 212 cannot be made too long. As a consequence, the potential arises in which the front portion of lever 212 (the part that is pulled away from cage 213) that serves as the part that manually held when extracting case 210 from cage 213, will be too short and thus ease of operability will suffer. If lever 212 is lengthened, ample room must be provided around the periphery of cage 213 for the rotation of lever 212 to maintain the large rotation range of lever 212. As a result, this form, similar to Japanese Patent Application Laid-open No. 119951/94 (H6-119951), has the serious drawback of impeding the high-density arrangement of optical modules and cages.

Still further, the locking mechanism of Japanese Patent Application Laid-open No. 2004-170594 is of a configuration in which center portion 212b of the front end of lever 212 is cut away. This form is adopted to prevent lever 212 from interfering with (catching on) an optical fiber while lever 212 is rotated when optical fiber (not shown) is connected to case 210. In other words, center portion 212b of the front end of the lever that can be considered to be most appropriate for allowing the user to rotate, pull out, and push in lever 212 has been cut away. As a result, the user must manipulate lever 212 by grasping the side portions of lever 212. This shape in which not only the length of lever 212 is shortened, as previously described, but in which this center portion 212b of the front end is cut away detracts from the operability of the lock release operation with using this lever 212.

The locking mechanism disclosed in Japanese Patent Application Laid-open No. 2004-309576 necessitates the provision of a new member, release member 224. In addition, space for this release member 224 to slide must be provided in case 221. In addition, leaf spring 223, which is provided with locking part 222, and release member 224 extend as far as the middle portion in the longitudinal direction of the optical module. Accordingly, a considerable amount of vacant space is required. In other words, this locking mechanism is made up of parts that are provided over a comparatively wide range of the longitudinal direction of the optical module. As a result, this configuration results in portions in the interior of the optical module that are used for the locking mechanism and that therefore cannot be effectively utilized as space for circuit implementation, thus hindering miniaturization. In addition, because release member 224 is a plate-shaped member, release member 224 is difficult to grasp during manipulation of the lock release and the operation of extracting case 221, and this locking mechanism therefore has the drawback of poor operability.

### SUMMARY OF THE INVENTION

An exemplary object of the invention is to provide a locking mechanism of an optical module and a method for locking and releasing a locking state of an optical module, this locking mechanism and method being capable of: solving the above-described problems of the related art, not hindering the high-density arrangement of a multiplicity of modules, providing excellent operability, and not detracting from space efficiency in an optical module.

In one exemplary aspect of the invention, an optical module locking mechanism for engaging and locking together a case, that makes up an optical module that incorporates elements for realizing optical communication, and a cage that accommodates the case includes: a locking member that is provided in the case in a manner that allows pivoting of the locking member and that includes a detaining projection that can engage with and be detained in a detaining hole formed in the cage; a lever that is provided in the case in a manner that allows the lever to slide parallel to the direction of extraction of the case from the cage; and a biasing member for biasing the lever toward a prescribed position; wherein: in a state in which the case is accommodated in the cage and in which the lever is in the prescribed position, the detaining projection of the locking member engages with and is detained in the detaining hole; and the lever, in the process of sliding from the prescribed position along the direction of extraction of the case against the biasing force of the biasing member, comes into contact with the locking member and causes the locking member to pivot within the case and thus release the detention of the detaining projection in the detaining hole.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a perspective view of the locking mechanism described in Japanese Patent Application Laid-open No. 119951/94;

FIG. 2 is a perspective view of the locking mechanism described in Japanese Patent Application Laid-open No. 2004-170594;

FIG. 3 is a side view of the locking mechanism described in Japanese Patent Application Laid-open No. 2004-309576;

FIG. 4a is a front elevation showing an optical module that includes a portion of the locking mechanism of an exemplary embodiment of the invention;

FIG. 4b is a side sectional view of an optical module that includes a portion of the locking mechanism of an exemplary embodiment of the invention;

FIG. 5 is a perspective view showing an exploded state of a portion of the optical module that includes the locking mechanism shown in FIGS. 4a and 4b;

FIG. 6a is a perspective view of the locking member of the locking mechanism shown in FIGS. 4a and 4b;

FIG. 6b is a side view of the locking member of the locking mechanism shown in FIGS. 4a and 4b;

FIG. 7 is a perspective view of the cage that includes a portion of the locking mechanism of an exemplary embodiment of the invention;

FIG. 8a is a perspective view showing the locked state of the locking mechanism of an exemplary embodiment of the invention;

FIG. 8b is a perspective view showing the state in which the locking function is released and the case is extracted in the locking mechanism of an exemplary embodiment of the invention;

FIG. 9a is a side sectional view showing the locking state of the locking mechanism of an exemplary embodiment of the invention;

FIG. 9b is a side sectional view showing the state in which the locking function is released in the locking mechanism of an exemplary embodiment of the invention;

FIG. 9c is a side sectional view showing the state in which the case is extracted after release of the locking function in the locking mechanism of an exemplary embodiment of the invention;

FIG. 10a is a side sectional view showing an enlarged view of the optical module in the locking state; and

FIG. 10b is a side sectional view showing an enlarged view of optical module in the state in which the locking function is released.

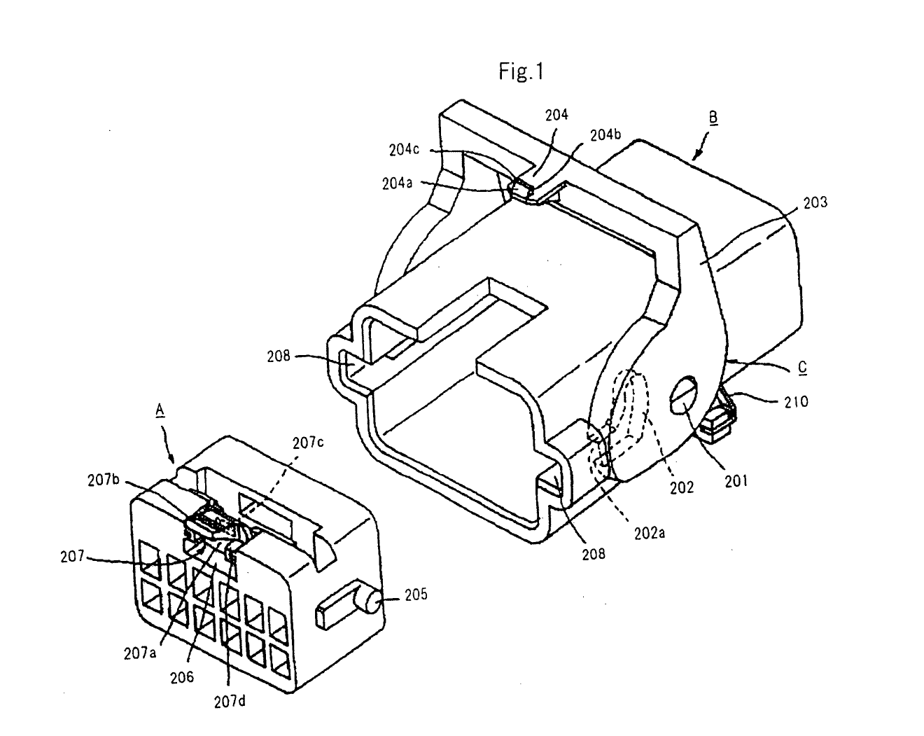

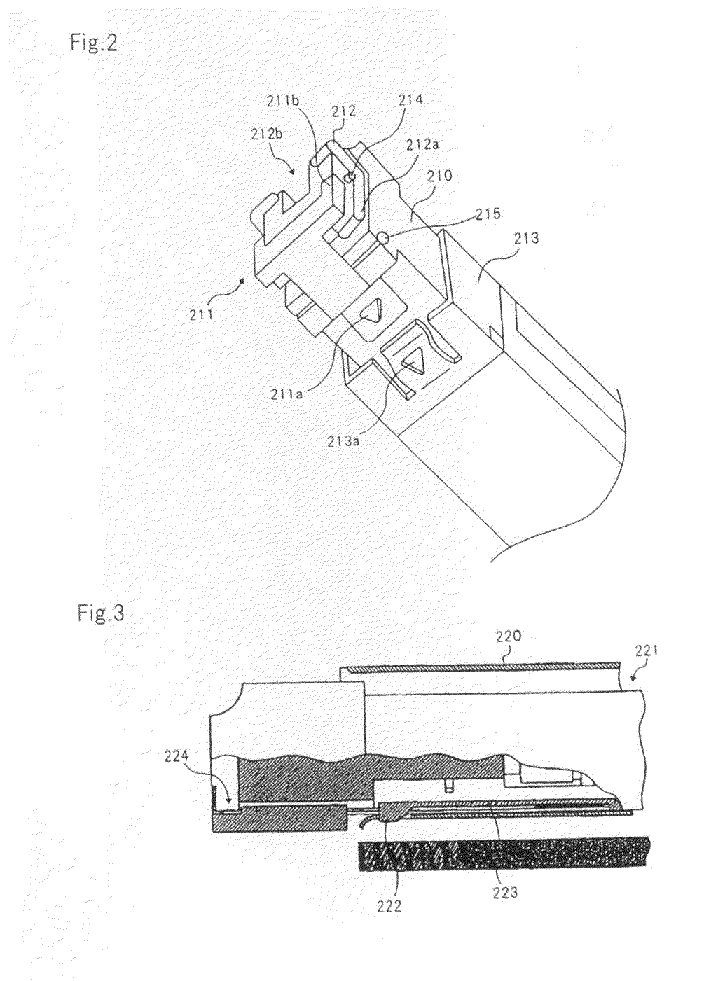

### DETAILED DESCRIPTION OF THE EXEMPLARY EMBODIMENTS

An exemplary embodiment of the invention is next described with reference to the accompanying drawings.

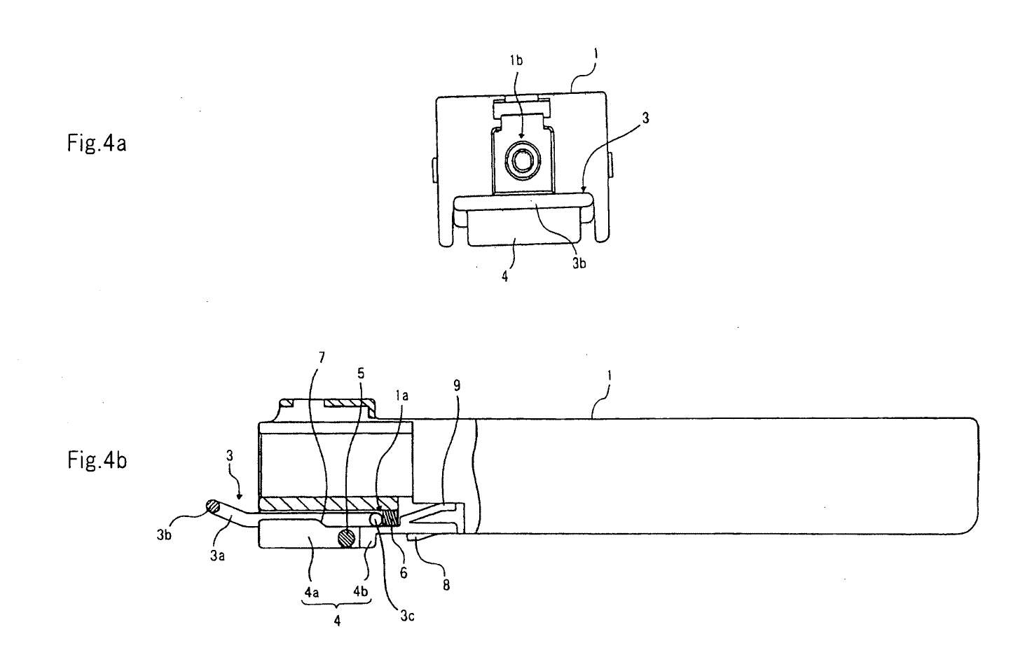

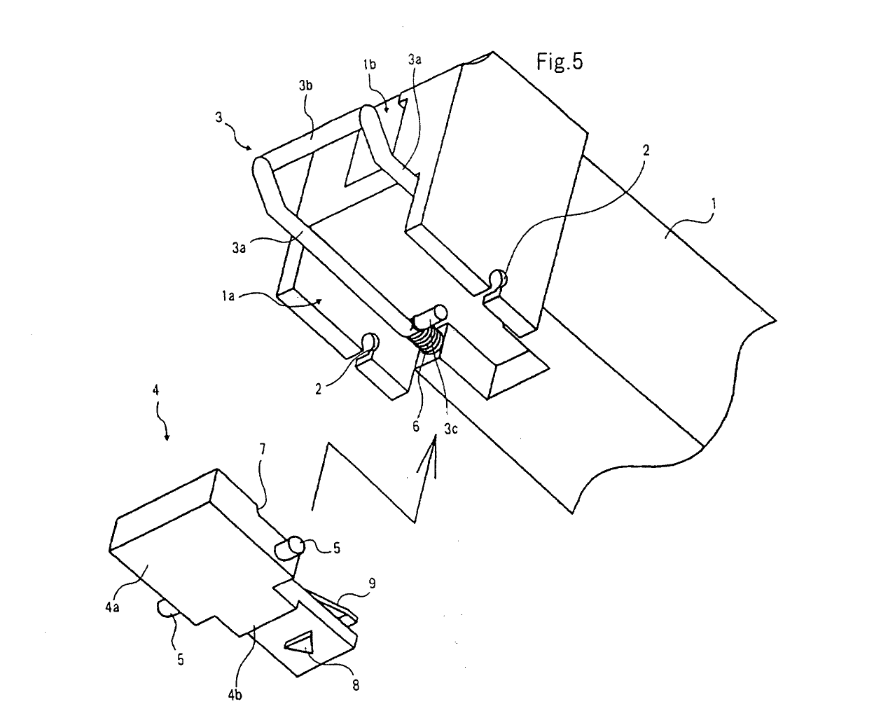

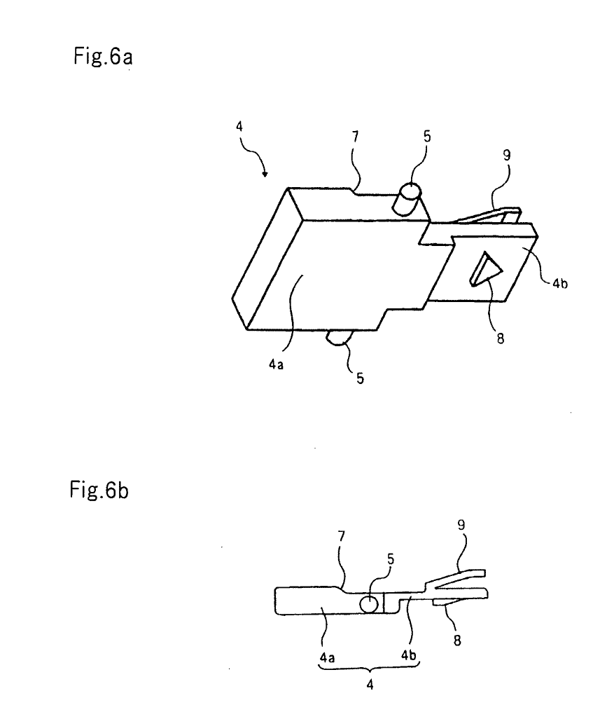

An optical module of an exemplary embodiment of the invention is first explained with reference to FIGS. 4a-7b. FIG. 4a is a front elevation showing the optical module that includes a portion of the locking mechanism of an exemplary embodiment of the invention. FIG. 4b is a side sectional view of this optical module. FIG. 5 is a perspective view showing the exploded state of a portion of the optical module that includes the locking mechanism. FIGS. 6a and 6b are a perspective view and a side view of the locking member.

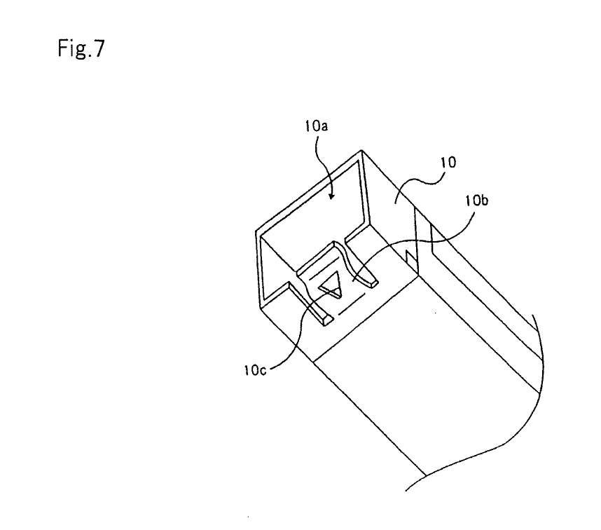

As shown in FIGS. 4a to 6b, the optical module of the exemplary embodiment is made up of: case 1 that constitutes a housing of the optical module; lever 3; and locking member 4. Lever 3 and locking member 4 are attached to the front portion (the left-side portion of FIG. 4b) of case 1. An optical unit (not shown) is incorporated in case 1. The optical unit includes elements for optical communication such as light-emitting elements and light-receiving elements such as LD (laser diodes) and PD (photodiodes). A connector unit (connection terminal not shown in the figure) is provided at the rear end surface of case 1 (the right-side end surface of FIG. 4b). When case 1 is accommodated inside cage 10 (see FIG. 7) that will be described hereinbelow, the' connector unit is connected to electrical connectors in cage 10. The optical module of the exemplary embodiment is for carrying out any of the transmission, reception, and transceiving of optical signals, and includes either or both of the above-described light-emitting elements and light-receiving elements. One example of the optical module is an optical transceiver that can be attached or detached in plug form (i.e., that is pluggable).

As shown in FIG. 5, fitting slots 2 are provided in the front portion of case 1. Support shafts (shaft-shaped projections) 5 of locking member 4 fit into these fitting slots 2. In this way, locking member 4 is attached to case 1 in a manner that allows a pivoting motion around support shaft 5.

Locking member 4 is made up of front portion 4a positioned on the front side of case 1 and rear portion 4b positioned on the rear side of case 1 with the above-described support shaft 5 as center, as shown in FIGS. 4a to 6b. Convex cam portion 7 is provided on the top surface of front portion 4a. Detaining projection 8 is provided on the bottom surface of rear portion 4b. Still further, elastically deformable spring 9 is integrally formed on the top-surface side of rear portion 4b. This locking member 4 can be formed integrally with support shafts 5. A resin such as PPS (polyphenylene sulfide) can be used as the material of this part.

Lever 3 is attached to attachment part 1a of case 1 by way of spring 6, which is a biasing member. Lever 3 can slide (parallel movement) in the longitudinal direction of case 1 within the range in which the spring can expand and contract. As explained below, the longitudinal direction of case 1 coincides with the direction of insertion and extraction of this optical module in cage 10.

Connection unit 1b is provided in the upper front portion (upper portion of attachment part 1a) of case 1. An optical fiber terminal (not shown) is installed in connection unit 1b. When attached to connection unit 1b, the optical fiber is connected to the optical unit (not shown) that is incorporated in case 1.

Lever 3 has a shape such as a bent wire and is made up of a pair of straight portions 3a, linking portion 3b, and engagement portions 3c. The pair of straight portions 3a extends in the longitudinal direction of case 1 near both sides of case 1. Linking portion 3b links both straight portions 3a at a position outside attachment part 1a of case 1. Engagement portions 3c are formed by inwardly bending the ends of both straight portions 3a that are on the opposite side from linking portion 3b. These engagement portions 3c extend to a point that allows contact with cam portion 7 when support shafts 5 are fitted into fitting slots 2 and locking member 4 is attached to case 1.

FIG. 7 shows box-shaped cage 10 in which one end is opening 10a in which the optical module having the above-described configuration is accommodated. Elastic tab 10b is provided on the inner bottom surface of this cage 10. Detaining hole 10c is formed on this tab 10b, and detaining projection 8 of case 1 fits into detaining hole 10c.

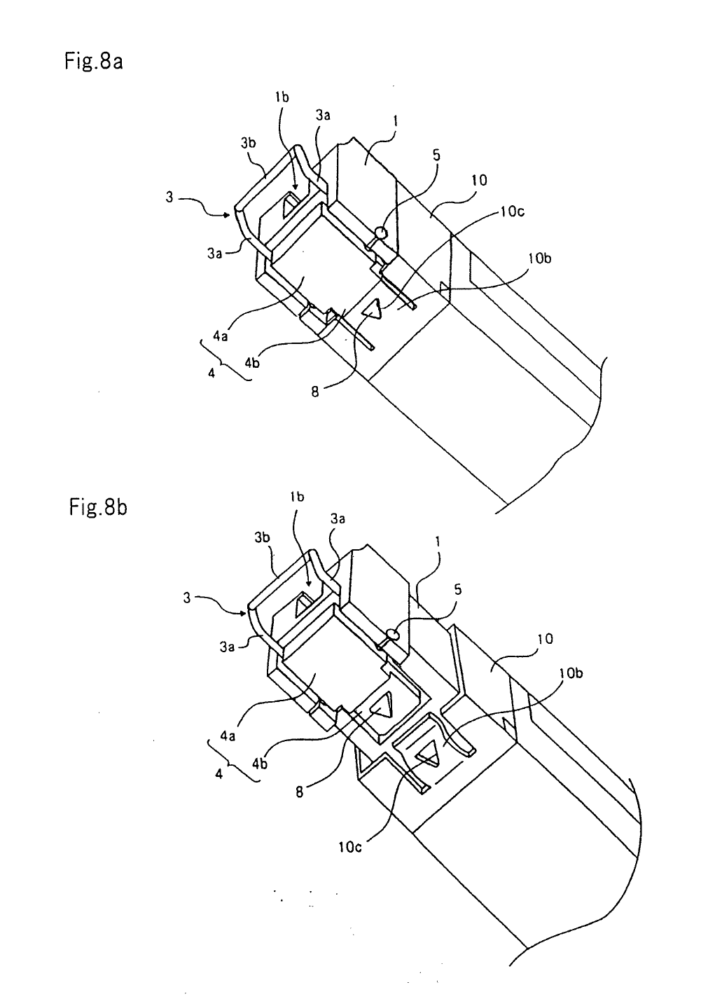

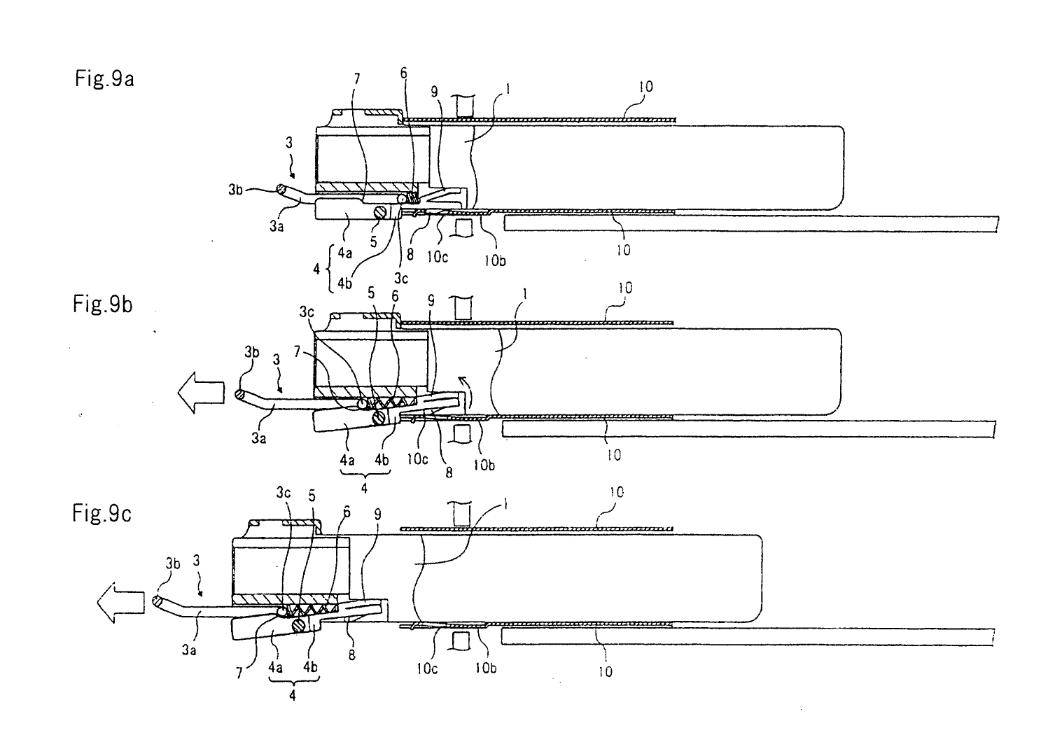

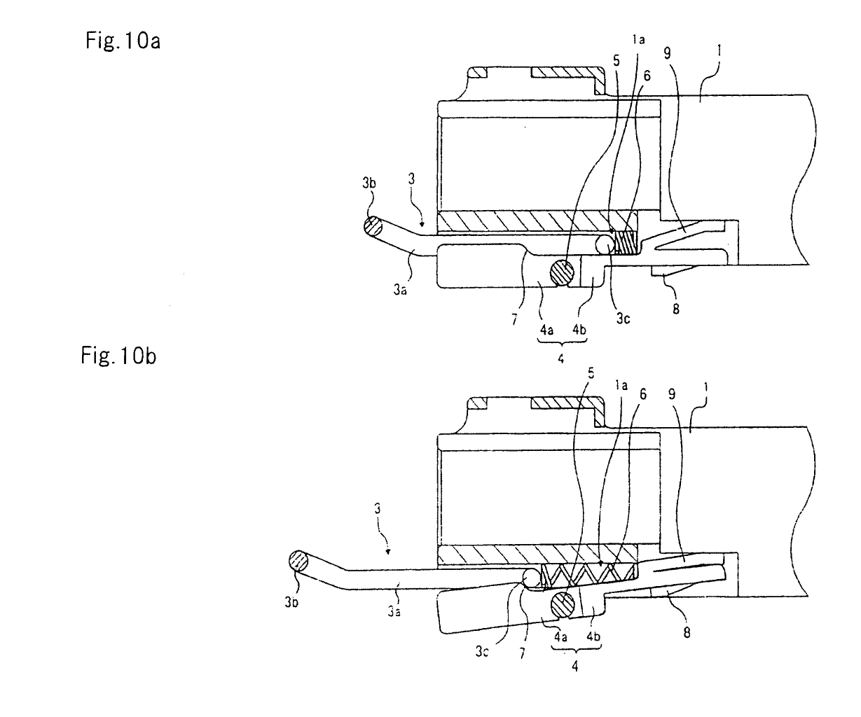

The locking mechanism and its action for securing together cage 10 and case 1 of the optical module of this exemplary embodiment are next described with reference to FIGS. 8a to 10b. FIG. 8a is a perspective view showing the state, in which case 1 and cage 10 are secured together. FIG. 9a is a side sectional view of case 1 and cage 10 in this state. FIG. 10a is an enlarged sectional view of case 1 in this state. FIG. 9b is a side sectional view of case 1 and cage 10 in which the locking state where case 1 is locked to cage 10 has been released. FIG. 10b is an enlarged sectional view of case 1 in this state. FIG. 8b is a perspective view of the state in which case l is being extracted from cage 10 or in which case 1 is being inserted into cage 10. FIG. 9c is a side sectional view of case 1 and cage 10 in this state.

As shown in FIGS. 8a and 9a, in the state in which optical module of this exemplary embodiment has been inserted into cage 10, although not shown, the connector unit formed at the rear end portion of case 1 of the optical module comes into contact with and electrically connects to the electrical connector that is provided deep inside cage 10. Therefore, the optical unit that is incorporated in case 1 and that includes elements for optical communication achieves electrical continuity with the electrical connector by way of the connector unit. Still further, when attached to connection unit 1b, an optical fiber is connected to the optical unit. As a result, the optical fiber that extends to the outside from case 1 is connected by way of the optical unit, the connector unit, and the electrical connector, to electrical components in cage 10 or to electrical components that are outside cage 10 but that are connected to the electrical connector.

Case 1 of the optical module and cage 10 are engaged and locked together by means of the locking mechanism when the optical module is accommodated in cage 10 in this way. More specifically, locking member 4 that is attached to case 1 is held in a state that is substantially horizontal to case 1. Detaining projection 8 of locking member 4 then enters detaining hole 10c of cage 10 and is thus detained, whereby case 1 is secured in cage 10 such that detachment will not occur. This state is referred to as a locking state. At this time, engagement portions 3c of lever 3 and cam part 7 of locking member 4 are positioned apart in the longitudinal direction of case 1 and do not contact, as shown in FIG. 10a. In this locking state, lever 3 is held stably by spring 6 at a prescribed position in which lever 3 is inserted within attachment part 1a. This prescribed position is the initial position of lever 3, and as long as external force is not applied, lever 3 is maintained at this initial position. In addition, spring 9 of locking member 4 contacts a portion of case 1. Thus, as long as external force is not applied against the biasing force of spring 9, the state in which detaining projection 8 is inserted into detaining hole 10c and in which locking member 4 is substantially horizontal to case 1 can be reliably maintained.

In this way, lever 3 is kept in the initial position (prescribed position) by spring 6, and moreover, locking member 4 is kept substantially horizontal with respect to case 1 by spring 9, whereby the above-described locking state is maintained. Accordingly, the state is maintained in which the electrical connector and the connector unit (not shown) are connected and optical communication is realized. Detachment of the optical module from cage 10 by mistake in the midst of optical communication is therefore prevented. In other words, the interruption of optical communication or malfunctioning of the module can be prevented.

In the initial position shown in FIGS. 8a, 9a, and 10a, a portion of lever 3 (linking portion 3b and the front parts of straight portions 3a ) protrudes to the outside from attachment part 1a of case 1. The direction of this protrusion matches the direction of extraction of case 1 from cage 10. When the user is removing the optical module from cage 10, lever 3 is pulled in the direction from opening 10a toward the outside (the direction from the right side and toward the left side in FIGS. 8a, 8b, 10a, and 10b; and the direction of protrusion of lever 3 and moreover, the direction of extraction of case 1). At this time, the locking state realized by locking member 4 (the state in which detaining projection 8 is engaged and locked in detaining hole 10c) is maintained and case 1 therefore still does not move.

If lever 3 is further pulled, lever 3 is caused to slide against the biasing force of spring 6 while extending spring 6 as shown in FIGS. 9b and 10b, engagement portions 3c of lever 3 come into contact with cam portion 7 of locking member 4. Engagement portions 3c then contact and press down cam portion 4b, whereby locking member 4 pivots around support shafts 5 while elastically deforming spring 9 against the biasing force of spring 9. Locking member 4 pivots such that front portion 4a drops and rear portion 4b rises. With this movement, detaining projection 8 of locking member 4 is removed from detaining hole 10c of cage 10. In this way, the locking state realized by locking member 4 is released.

When the locking state realized by locking member 4 is released in this way, the action of securing case 1 of the optical module inside cage 10 is eliminated. Accordingly, when the operator continues to pull lever 3, case 1 moves in the same direction as the sliding of lever 3 and is extracted to the outside from opening 10a as shown in FIGS. 8b and 9c. At this time, the optical module is kept in the same state as shown in FIG. 10b.

When engagement portions 3c of lever 3 come into contact with cam portion 7 of locking member 4 in this way, locking member 4 pivots and detaining projection 8 is removed from detaining hole 10c. In this state, lever 3 is pulled and case 1 moves, whereupon, because detaining projection 8 and detaining hole 10c are positioned apart in the longitudinal direction of case 1, detaining projection 8 does not re-enter detaining hole 10c. Accordingly, the locking state of locking member 4 remains being released. As a result, the extraction of the optical module is effected smoothly to completion.

After optical module is extracted from cage 10, the state is identical to that shown in FIG. 10a in which spring 6 recovers and lever 3 returns to its initial position. As a result, lever 3 does not protrude greatly from case 1 and does not interfere with handling. When lever 3 returns to its initial position, the biasing force of spring 9 causes locking member 4 to return to a state in which it is substantially horizontal with respect to case 1. As a result, front portion 4a of locking member 4 is not kept in a state protruding below case 1 and does not interfere with handling.

According to this exemplary embodiment, two processes, i.e., the above-described release of the locking state of the locking member 4 and the extraction of case 1 from cage 10, are carried out as a continuous operation. The operator merely continues to pull lever 3 and the operation is carried out as a single action without any changes midway through the operation. The configurations disclosed in Japanese Patent Application Laid-open No. 2004-170594 and Japanese Patent Application Laid-open No. 2004-309576 require operation of at least two steps such as the pivoting and parallel movement of the lever. In this exemplary embodiment, however, the extraction of case 1 is completed by operation of a single step, and operability is therefore extremely high. In addition, the operation is carried out even more easily when the operator grasps and manipulates linking portion 3b of lever 3. Lever 3 is a wire-shaped member and is not a flat-plate-shaped member. Because lever 3 does not pivot, there is no danger of interference with optical fiber, and further, no need to cut away the center portion of the front end of lever 3 (linking portion 3b). Accordingly, it is easy to handle, and further, the optical module is easy to hold after extraction from cage 10.

In relation to the above-described operation of extracting the optical module, because no limits apply to the length of lever 3, lever 3 can be freely formed to any length that facilitates handling. To explain this point, because a pivoting action of lever 3 is not effected in this exemplary embodiment, there is no need to provide vacant space in the vicinity of case 1 and cage 10 (for example, above and below cage 10) to allow the pivoting of lever 3. In other words, lever 3 can be formed to any length without concern for the space around cage 10. In addition, the direction of projection and the direction of sliding of lever 3 both coincide with the direction of extraction of case 1 from cage 10. From the outset, sufficiently ample space is secured in this direction because no member that might potentially be an obstacle is arranged so that extraction of case 1 from cage 10 is not hindered. As a result, a long extension of lever 3 in this direction presents no problems and is not an obstacle to the high-density arrangement of case 1 and cage 10. Accordingly, lever 3 can be caused to project to the outside from attachment part 1, a length that is sufficient to allow easy operation and thus achieve an improvement in operability.

Still further, because the direction of sliding that is the only action of lever 3 coincides with the direction in which force is applied for extracting case 1 from cage 10, the operation can be realized efficiently and with no loss of power.

According to the exemplary embodiment as described hereinabove, the locking state of locking member 4 is released and extraction of case 1 from cage 10 is completed by only the action of pulling lever 3 in the direction of extraction of case 1, which is the longitudinal direction of case 1, i.e., the direction toward the outside from opening 10a. As a result, working space in a direction that intersects this direction is unnecessary. Accordingly, when a multiplicity of optical modules is arranged in vertical and horizontal rows, the optical modules can be arranged at high density and at a small pitch.

This locking mechanism can be configured in an extremely small area in the vicinity of the front end portion of an optical module. As a result, this locking mechanism does not impair space efficiency and poses little interference to the arrangement of circuits in the optical module.

In the locking mechanism of this exemplary embodiment, spring 6 is provided to return lever 3 to its initial position. Accordingly, there is no need to press lever 3 back by hand each time after the locking state has been released. Then, after case 1 has been extracted from cage 10, handling and storing are facilitated because lever 3 does not remain in a state in which it projects more than is necessary.

Cage 10 can be constructed by bending a metal plate such as stainless steel (SUS). In addition, case 1 can be constructed by bending a metal plate such as stainless steel (SUS). Alternatively, case 1 can also be constructed by molding a resin such as PPS (polyphenylene sulfide) similar to the formation of locking member 4.

In the exemplary embodiment described hereinabove, lever 3 is linked to case 1 by way of spring 6. However, although not shown in the figures, lever 3 can take the form of a double cylindrical construction that can expand and contract with spring 6 installed inside. In this case, lever 3 can be made short so as not to present an obstacle when not in use and then made longer to facilitate operation only when in use (when pulled).

As described hereinabove, according to the exemplary embodiment, the locking state can be released by merely sliding lever 3 in one direction, i.e., by merely sliding lever 3 along the direction in which case 1 is extracted from cage 10. The operability is superior because a plurality of operations is not needed to release the locking state. In addition, the operation in which the locking state is to be released and the operation for extracting case 1 after the locking state has been released can be carried out as a continuous action in the same direction. As a result, the operability is exceedingly good.

The action of lever 3 for releasing the locking state is not accompanied by an action in a direction that intersects the direction of insertion of case 1 to cage 10 or the extraction of case 1 from cage 10, and as a result, space need not be provided for operating lever 3 in the vicinity of cage 10 (in particular, above or below the cage). A multiplicity of optical modules can therefore be arranged at high-density and at small pitch.

Finally, because the locking mechanism is provided only at one end of the optical module, space in the interior of the optical module is used with high efficiency for arranging, for example, circuits.

According to the exemplary embodiment, a locking mechanism of an optical module can be provided that does not hinder the high-density arrangement of a multiplicity of optical modules, that features superior operability, and that does not detract from space efficiency in the optical module.

While exemplary embodiments of the present invention have been described using specific terms, such description is for illustrative purposes only, and it is to be understood that changes and variations may be made without departing from the spirit or scope of the following claims.

What is claimed is:

1. An optical module locking mechanism for engaging and locking together a case, which makes up an optical module that incorporates elements for realizing optical communication, and a cage that accommodates the case, comprising:
a locking member that is provided in said case in a manner that allows pivoting of the locking member and that includes a detaining projection that can engage with and be detained in a detaining hole formed in said cage;
a lever that is provided in said case in a manner that allows said lever to slide parallel to the direction of extraction of said case from said cage; and
a biasing member provided in said case for biasing said lever toward a prescribed position,
said detaining projection of said locking member engaging with and detained in said detaining hole in a state in which said case is accommodated in said cage and in which said lever is in said prescribed position, and said lever, in a process of sliding from said prescribed position along the direction of extraction of said case and against the biasing force of said biasing member, coming into contact with said locking member and causing said locking member to pivot within said case and thus releasing the detention of said detaining projection in said detaining hole.

2. The optical module locking mechanism as set forth in claim 1, wherein:
said locking member has shaft-shaped projections that serve as the center of pivoting; and
said case has fitting slots into which said shaft-shaped projections rotatably fit.

3. The optical module locking mechanism as set forth in claim 2, wherein:
said locking member includes a front portion positioned closer to the forward side of said case than said shaft-shaped projections and that is provided with a cam portion, and a rear portion positioned closer to the rearward side of said case than said shaft-shaped projections and that is provided with said detaining projection; and
said lever includes an engagement portion that is configured to, in the process of sliding along the direction of extraction of said case, engage with said cam portion of said locking member, press down said cam portion, and cause said locking member to pivot inside said case.

4. The optical module locking mechanism as set forth in claim 3, wherein said locking member includes a spring for biasing said rear portion of said locking member such that said detaining projection is arranged in a position to be detained in said detaining hole when said case is accommodated in said cage.

5. The optical module locking mechanism as set forth in claim 1, wherein said cage has a box shape in which one end is an opening; and said opening serves both as the entrance when inserting said case into said cage and as the exit when extracting of said case from said cage and allows sliding of said lever in a direction that is parallel to the direction of extraction of said case.

6. The optical module locking mechanism as set forth in claim 1, wherein a portion of said lever projects from one end portion of said case in a direction that is parallel to the direction of extraction of said case in a state in which said case is accommodated in said cage and in which said lever is in said prescribed position.

7. A method of locking an optical module for locking together a case, which makes up an optical module that incorporates elements for realizing optical communication, and a cage that accommodates said case, and of releasing said optical module from locking state, said method comprising steps of:
causing a detaining projection of a locking member to be detained in a detaining hole of said cage in a state in which said case is accommodated in said cage and in which a lever provided in said case is in a prescribed position while being biased by a biasing member provided in said case; and
causing said lever to slide from said prescribed position along the direction of extraction of said case and against the biasing force of said biasing member, causing said lever to come into contact with said locking member midway during the slide, and causing said locking member to pivot in said case and thereby release the detention of said detaining projection in said detaining hole.

8. The method of locking an optical module and of releasing the locking state as set forth in claim 7, wherein pivoting of said locking member is realized around shaft-shaped projections that are fitted into fitting slots provided in said case.

9. The method of locking an optical module and of releasing the locking state as set forth in claim 8, wherein releasing of detention of said detaining projection in said detaining hole is realized by steps wherein:
engagement portions provided on said lever engage with a cam portion that is provided on a front portion of said locking member and thus press the cam portion midway during said slide of said lever, said front portion being positioned closer to the forward side of said case than shaft-shaped projections; and
said locking member pivots in said case and thus causes a detaining projection provided on a rear portion of said locking member to exit from said detaining hole, said rear portion being positioned closer to the rear side of said case than said shaft-shaped projections.

10. The method of locking an optical module and of releasing the locking state as set forth in claim 9, wherein detention of said detaining projection of said locking member in said detaining hole is realized by biasing said rear portion of said locking member by means of a spring provided on said locking member.

11. The method of locking an optical module and of releasing the locking state as set forth in claim 7, wherein said sliding of said lever is realized in a direction parallel to the direction of extraction of said case by way of an opening that is formed on one end of said cage and that serves as entrance when inserting said case into said cage and as an exit when extracting said case from said cage.

12. The method of locking an optical module and of releasing the locking state as set forth in claim 7, wherein said sliding of said lever is realized by pulling a portion that projects from one end of said case in a direction parallel to the direction of extraction of said case from a state in which said case is accommodated in said cage and in which said lever is in said prescribed position.
